(19) United States
(12) Patent Application Publication
(10) Pub. No.: US 2006/0120712 A1
(43) Pub. Date: Jun. 8, 2006

(54) Method and apparatus for processing image

(75) Inventor: Seong-Hwan Kim, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/296,665

(22) Filed: Dec. 7, 2005

(30) Foreign Application Priority Data
Dec. 7, 2004 (KR) 102386/2004

(51) Int. Cl. G03B 41/00

(52) U.S. Cl. 396/333

(57) ABSTRACT

Provided is a method and apparatus for processing an image, in which an image is removed from the entire photographed image and synthesized with another image using distance information to a photographed object regardless of colors or patterns of the image. The method includes the steps of photographing images using two cameras, extracting distance information to a photographed object using a disparity between the images, and processing the images of the photographed object at a predetermined distance using the extracted distance information.

### PRIORITY

This application claims priority under 35 U.S.C. § 119 to an application entitled “Method and Apparatus for Processing Image” filed in the Korean Intellectual Property Office on Dec. 7, 2004 and assigned Ser. No. 2004-102386, the contents of which are incorporated herein by reference.

### BACKGROUND OF THE INVENTION

1. Field of the Invention

The present invention generally relates to a method and apparatus for processing an image, and in particular, to a method and apparatus for processing an image, in which an image of an object at a predetermined distance from a camera is removed from the entire photographed image or is synthesized with another image in video conferencing or image photography.

2. Description of the Related Art

In photographing moving or still images, a technique for removing a background around a user or a predetermined object and changing that background into a user-set background can provide various services to the user. The core of this technique is to accurately extract an image of an object to be removed from the entire image photographed by a camera.

To this end, conventionally, an image to be removed is extracted through pattern recognition such as detection of colors or edges from an image acquired by a single camera. However, division between an object to be removed and an object to be left is vague, and based only on one-dimensional image information, and thus there is a high possibility that an error may occur in extracting the object due to the limitations of pattern recognition. For example, when a background includes the same color as a person's clothes, division between the person to be removed and the object to be left becomes less clear in a one-dimensional image. Moreover, since such conventional pattern recognition requires multiple processing steps, it is difficult to implement with respect to a moving image composed of multiple frames per second in a system that needs to process an image in real time.

### SUMMARY OF THE INVENTION

It is, therefore, an object of the present invention to provide a method and apparatus for processing an image, in which an image of an object can be removed from the entire photographed image or can be synthesized with another image using distance information of the object.

It is another object of the present invention to provide a method and apparatus for processing an image, in which the same object is photographed using two cameras, distance information of the object is extracted using a disparity between the cameras, and an image of the object can be removed from the entire photographed image or can be synthesized with another image.

It is still another object of the present invention to provide a method and apparatus for processing an image, in which a user can selectively remove an image or can synthesize an image with another image by directly inputting a range of a distance of the photographed image to be removed from the entire photographed image.

It is yet another object of the present invention to provide a method and apparatus for processing an image, in which an image of an object to be processed is accurately extracted regardless of its color or pattern.

To this end, a method for processing an image according to the present invention comprises photographing images of an object using two cameras, extracting distance information of the object using a disparity between the images, and processing an image of an object at a predetermined distance using the extracted distance information.

To achieve the above and other objects, there is provided a method for processing an image. The method includes photographing images of an object using two cameras, mapping corresponding pixels in the images with respect to the same object, calculating the disparity as a difference between positions of the corresponding pixels with respect to the same object in the images, extracting the distance information to the photographed object using the calculated disparity, removing the image of the photographed object at a predetermined distance using the extracted distance information, and synthesizing another image into a portion corresponding to the removed image.

Mapping of the corresponding pixels is performed by comparing correlations in units of a sub-block with respect to the images. The distance information to the photographed image is preferably calculated using distance information between centers of the cameras, focus length information of each of the cameras, and the disparity.

To achieve the above and other objects, there is also provided an apparatus for processing an image. The apparatus includes two cameras for photographing images, a pixel mapping unit for mapping corresponding pixels in the images photographed by the cameras with respect to the same object, a distance information extracting unit for calculating a disparity between the images as a difference between positions of the corresponding pixels with respect to the same object in the images and extracting distance information to the photographed object using the disparity, and an image synthesizing unit for processing the images of the photographed object at a predetermined distance using the distance information.

The two cameras are installed apart by a predetermined distance by making epipolar lines of the two cameras coincident. The images are the same-size images acquired by photographing the same object at the same time.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a method for processing an image according to the present invention;

FIG. 2 is a view for explaining a process of mapping corresponding pixels to each other according to the present invention;

FIG. 3 is a view for explaining a process of calculating a disparity between two images and a distance to a photographed object according to the present invention;

FIG. 4 shows an example in which a user removes a background and another image is synthesized into a portion corresponding to the removed background according to the present invention; and

FIG. 5 is a block diagram of an apparatus for processing an image.

### DETAILED DESCRIPTION OF THE PREFERRED EMBODIMENT

A preferred embodiment of the present invention will now be described in detail with reference to the annexed drawings.

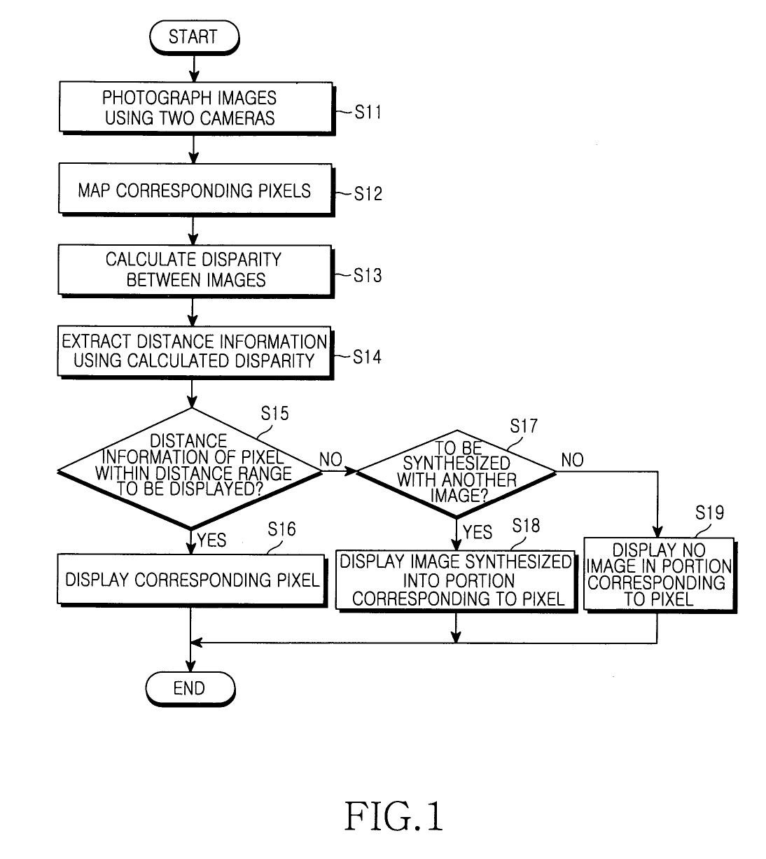

FIG. 1 is a flowchart illustrating a method for processing an image using distance information according to the present invention.

In step S11, images are photographed using two cameras (hereinafter, referred to as a first camera and a second camera) to extract distance information. It is preferable that a first image photographed by the first camera and a second image photographed by the second camera are the same-size images acquired by photographing the same object at the same time. To calculate a disparity between the first image and the second image, it is preferable that the first image and the second image are photographed symmetrical to each other by making epipolar lines of the first camera and the second camera coincident.

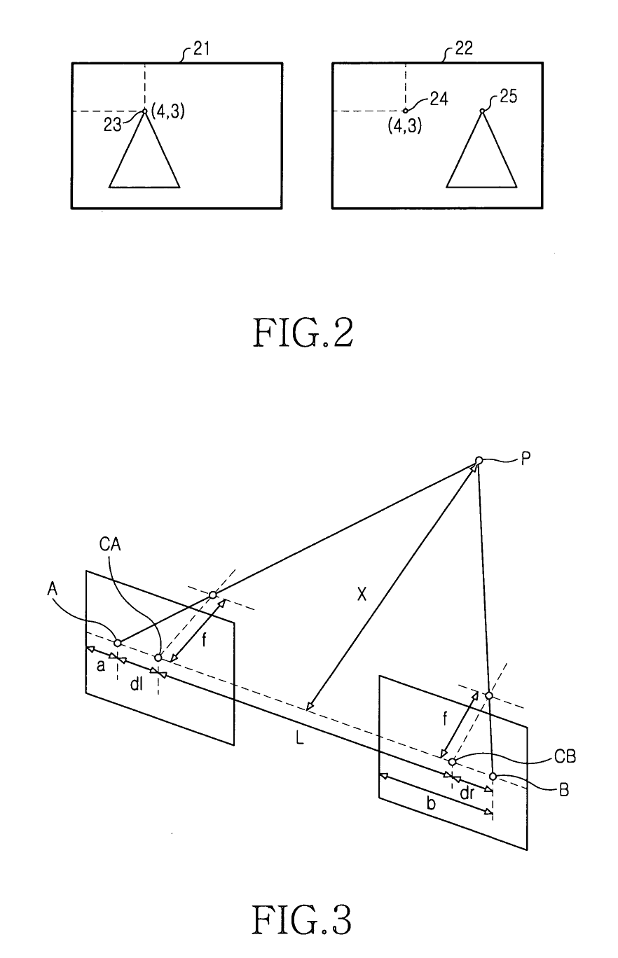

Once the first image and the second image are photographed by the first camera and the second camera, respectively, corresponding pixels with respect to the same object in the first image and the second image are mapped to each other in step S12. Herein, mapping corresponding pixels to each other is accomplished not by mapping pixels having the same coordinates in the first image and the second image, but by searching in the first image and the second image for pixels corresponding to the same shape and position with respect to the same object, and mapping the found pixels to each other. Referring to FIG. 2, a pixel 23 with coordinates (4, 3) in a first image 21 is mapped to a pixel 25 in a second image 22, instead of a pixel 24 with the same coordinates (4, 3) as the pixel 23. Since the pixel 23 of the first image 21 is a vertex of a triangle, it is mapped to the pixel 25 corresponding to the same shape and position with respect to the same object, i.e., the triangle (the shape and position of the pixel 25 are the same as those of the pixel 23 in that the pixel 25 is the top vertex and not the two vertices at the base of the triangle), in the second image 22.

Mapping corresponding pixels to each other is performed by storing the first image and the second image in a memory, calculating a correlation for each subblock, and searching for corresponding pixels.

Once the corresponding pixels with respect to the same object in the first image and the second image are mapped to each other, a disparity between the first image and the second image is calculated using corresponding pixel information in step S13, and a distance to the photographed object is calculated using the calculated disparity in step S14. In other words, the disparity between the first image and the second image is calculated using a difference between positions of the same object in the first image and the second image and a distance to the object is calculated.

Hereinafter, calculation of the disparity between the first image and the second image and the distance to the photographed object will be described in more detail with reference to FIG. 3.

P represents an object to be photographed, and A and B represent images of the object P photographed by a first camera and a second camera, respectively. CA represents the center of the image photographed by the first camera and CB represents the center of the image photographed by the second camera.

Parameters used in the calculation are as follows:

L: A distance between the center of the first camera (CA) and the center of the second camera (CB)

f: A focus length of the first camera or the second camera

dl: A distance from the center of the first camera (CA) to the image A photographed by the first camera

dr: A distance from the center of the second camera (CB) to the image B photographed by the second camera

a: A distance from a left reference face of the entire image photographed by the first camera to the image A photographed by the first camera

b: A distance from a left reference face of the entire image photographed by the second camera to the image B photographed by the second camera

X: A distance from the middle point between the centers of the first camera and the second camera to the photographed object P

In FIG. 3, X is calculated as follows In Equation (1):
X=(L×f)/(dl+dr) (1)

Since (dl+dr) is equal to (b−a), Equation (1) can be arranged as follows In Equation (2):
X=(L×f)/(b−a) (2),
where (b−a) is a relative difference, i.e., a disparity, between the image A acquired by photographing the object P using the first camera and the image B acquired by photographing the object P using the second camera.

Once the distance L between the center of the first camera (CA) and the center of the second camera (CB), the focus length f of the first camera or the second camera, and the disparity between the image A and the image B are given, the distance X to the photographed object P can be calculated using Equation (2). Among those parameters, there is a high possibility that the distance L and the focus length f are fixed. Therefore, once the disparity is given, the distance X to the photographed object P can be easily acquired. It can be understood from Equation (2) that as the disparity increases, the distance X to the photographed object P decreases, and vice versa. In the present invention, an image of an object can be accurately discerned from the entire photographed image using such distance information when compared to using color or edge information.

Hereinafter, the present invention will be described in more detail by taking an example in which the present invention is applied to a mobile phone. As can be seen from Equation (2), the present invention is influenced by a distance between the centers of cameras, a focus length of a camera, and a disparity between photographed images. Thus, distance measurement precision or distance measurement range may change according to the type of cameras and a distance between the centers of the cameras mounted in a mobile phone.

In an embodiment of the present invention, it is assumed that each of two cameras has a Complementary Metal-Oxide Semiconductor (CMOS) image sensor and a focus length of 3 mm, and a distance between the centers of the two cameras is 5 cm. If an image photographed through the CMOS image sensor has a size of 1152×864, the size of a pixel of the image is 3.2 μm. Thus, a disparity between images can be detected with a resolution of 3.2 μm.

The smallest distance XL to an object, which can be detected by the mobile phone, can be expressed as follows in Equation (3):
XL=(L×f)/(width of image sensor) (3),
where a unit of XL is cm. Since a disparity between images is largest when an object is located at the smallest distance XL that can be detected by the mobile phone, the disparity is equal to the width of horizontal pixels of an image, i.e., the width of the CMOS image sensor.

Once parameter values are substituted into Equation (3), XL=(5×0.3)/(1152×0.00032). Thus, the smallest distance XL that can be detected by the mobile phone is about 5 cm.

The largest distance XH that can be detected by the mobile phone is expressed as follows in Equation (4):
XH=(L×f)/(size of pixel) (4),
where a unit of XH is cm. Since a disparity between images is smallest when an object is located at the largest distance XH that can be detected by the mobile phone, the disparity is equal to the length of a pixel.

Once parameter values are substituted into Equation (4), XH=(5×0.3)/(0.00032). Thus, the mobile phone can recognize an object at a distance of up to about 46 m. Since an object at a distance larger than 46 m is displayed as being located at the same position as an object at the largest distance, i.e., 46 m, removal of an object a distance larger than 46 m does not become an issue.

As can be understood from Equation (2), fine measurement is possible as a distance to an object decreases, and resolution decreases as the distance to the object increases. However, when a user performs a video conference using a mobile phone, a distance between the user and the mobile phone having a camera mounted therein would not exceed the length of the user's arms. Therefore, a sufficiently high resolution can be secured, which can be verified using Equation (2). When a user performs a video conference and a distance between the user and a camera is about 30 cm, a disparity calculated using Equation (2) is 0.5 mm and the size of a pixel is 3.2 μm. Thus, a resolution that is sufficiently high to recognize a distance difference of about 2 mm can be secured. In other words, an object apart from a user who performs a video conference by a distance of 2 mm or less can be discerned. In the present invention, an object apart from another object by a small distance can be discerned and be removed.

Once distance information of each pixel is extracted, it is determined whether the distance information of each pixel is within a distance range to be displayed in the entire photographed image, in step S15. If distance information of a pixel is within such a distance range, the pixel is displayed in step S16. Unless the distance information of the pixel is within the distance range, it is determined whether to synthesize another image into a portion corresponding to the pixel in step S17. If it is determined to synthesize another image into the portion corresponding to the pixel, another image is synthesized into the portion corresponding to the pixel and is displayed in step S18. In other words, another image is displayed in a portion corresponding to a pixel whose distance information is not within a distance range to be displayed in the entire photographed image. If the distance information of the pixel is not within the distance range and it is determined not to synthesize another image into the portion corresponding to the pixel, then there is no image displayed in the portion corresponding to the pixel in step S19. In brief, distance information of each pixel is extracted, and if distance information of a pixel is not within a distance range to be displayed in the entire photographed image, the pixel is removed from the entire photographed image and another image is synthesized into a portion corresponding to the removed pixel. An example of steps S15 through S19 can be expressed as a program as follows:

for (x=0; x<=1152 (number of horizontal pixels in image); x++)
{
for (y=0; y<=864 (number of vertical pixels in image); y++)
{
if (d(x.y)>=Disp_L && d(x,y)<=Disp_H )
{
SetPixel(x,y,image_from_camera(x,y));
}
else
{
SetPixel(x,y,image_from_userdefine(x,y);
}
}
}

In the above program, parameters are as follows:

x: A position of a pixel in an X-axis direction in an image

y: A position of a pixel in a Y-axis direction in an image

d (x, y): A disparity between pixels at coordinates (x, y)

Disp_L: A disparity when a distance to an object is smallest

Disp_H: A disparity when a distance to an object is largest

In other words, according to the program, a distance range DP which allows a pixel to be displayed in the entire photographed image is Disp_L≦DP≦Disp_H. Once distance information of a pixel to be displayed in the entire photographed image is given, Disp_L and Disp_H are easily calculated using Equation (2). SetPixel (x, y, image_from_camera(x, y)) represents a function indicating an image photographed by a camera when corresponding coordinates are within the distance range DP. SetPixel (x, y, image_from_userdefine(x, y)) represents a function indicating a preset image to substitute for a photographed image when corresponding coordinates are not within the distance range DP.

When an image of an object at a predetermined distance is removed from the entire photographed image and another image is synthesized into a portion corresponding to the removed object, a distance to an object to be removed and an image to be synthesized may be set to default values or set by a user. Alternatively, a user may change the distance and the image that have been set to the default values.

For example, a user who performs a video conference using a mobile phone generally attempts the video conference at a distance of about 15 cm-1 m from the mobile phone. Thus, a disparity between images photographed by cameras is calculated and converted into a distance and a distance of 15 cm-1 m is set to a default value. If distance information of a pixel in a photographed image corresponds to the default value, the pixel is displayed on a screen and the remaining pixels are removed. An image that is set as a default value or set by a user is synthesized into a portion corresponding to the removed pixels.

When a user sets an image to be synthesized, the user can manually control a distance range in which a pixel can be displayed while checking a screen from which an image at a predetermined distance is removed through a preview function of the camera before performing a video conference. At this time, the user can directly input the distance range in units of cm or m, and the distance range is converted into a disparity using Equation (2) and is set to Disp_L and Disp_H of the program.

Setting a distance range may be implemented as a progress bar to allow a user to control the progress bar while directly checking a range of an image to be removed through the preview function. At this time, Disp_L and Disp_H are automatically set according to the progress bar. For example, if a user who sends only his/her picture in his/her office during a video conference desires to send both his/her picture and a picture of his/her office and not to send a background over the window, the user can send his/her picture and the picture of the office except for the background over the window by controlling a distance range using the progress bar. Such a process of removing an image and synthesizing an image with another image while controlling a distance range in real time cannot be performed by conventional pattern recognition using one camera.

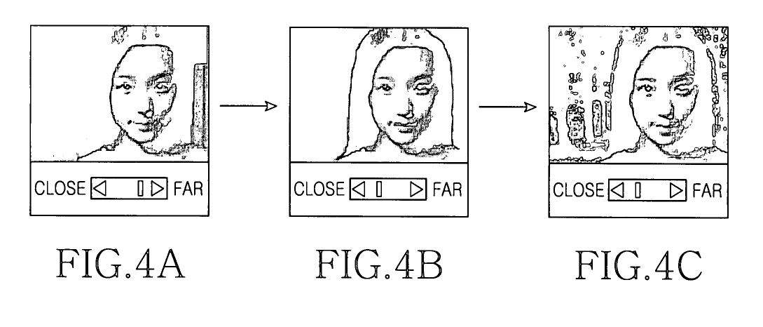

FIG. 4 shows an example in which a user removes a background and another image is synthesized into a portion corresponding to the removed background according to the present invention.

In FIG. 4A, both a user and a background are shown by increasing a distance to be displayed. In FIG. 4B, the user decreases a distance to be displayed using a progress bar to allow only an image of the user to be displayed and an image of the background is removed. In FIG. 4C, another background image is synthesized into the removed background in the state shown in FIG. 4B.

It is preferable that a display on a screen is an image photographed by one of two cameras. Since there is a disparity between the two cameras, a difference occurs in distances from the two cameras to a photographed object. However, since distance information used in the present invention is not a distance from the middle point between the centers of the two cameras to the object, but a distance from the center of each of the two cameras to the object, such a difference does not become an issue.

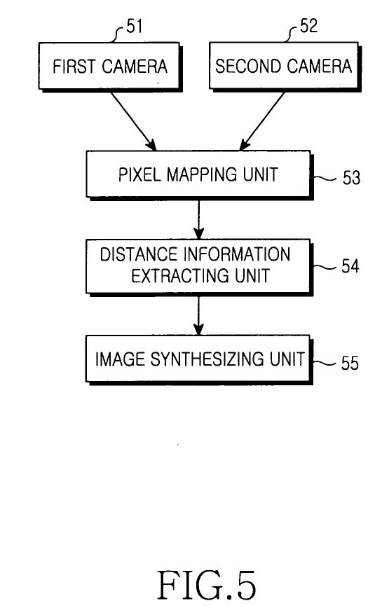

FIG. 5 is a block diagram of an apparatus for processing an image.

Referring to FIG. 5, the apparatus includes a first camera 51, a second camera 52, a pixel mapping unit 53, a distance information extracting unit 54, and an image synthesizing unit 55.

The first camera 51 and the second camera 52 are installed apart from each other by a predetermined distance. A first image photographed by the first camera 51 and a second image photographed by the second camera 52 are stored in the pixel mapping unit 53. It is preferable that the first image and the second image are same-sized images acquired by photographing the same object at the same time. To calculate a disparity between the first image and the second image, it is preferable that the first image and the second image are photographed symmetrically to each other by making epipolar lines of the first camera 51 and the second camera 52 coincident.

The pixel mapping unit 53 searches the first image and the second image for corresponding pixels with respect to the same object and maps the found pixels to each other. Mapping corresponding pixels to each other is not directed to mapping pixels having the same coordinates in the first image and the second image, but is directed to searching in the first image and the second image for pixels corresponding to the same shape and position in the same object, and mapping the found pixels to each other. Mapping corresponding pixels to each other is performed by storing the first image and the second image in a memory, calculating a correlation for each subblock, and searching for corresponding pixels.

The distance information extracting unit 54 calculates a disparity between the first image and the second image using the corresponding pixels mapped by the pixel mapping unit 53 and calculates a distance from each of the first camera 51 and the second camera 52 to the photographed object. Calculation of the disparity and the distance is already described above.

Once the distance extracting unit 54 extracts distance information for each pixel, the image synthesizing unit 55 removes an image of a corresponding object from the entire photographed image using the extracted distance information or synthesizes another image into a portion corresponding to the removed image. When the image synthesizing unit 55 removes an image of an object at a predetermined distance from the first image or the second image and synthesizes another image into a portion corresponding to the removed image, a distance to an object to be removed and an image to be synthesized may be preset to default values or may be set by a user. Alternatively, the user may change the distance and the image that have been preset to the default values.

A display on a screen is an image photographed by one of the first camera 51 and the second camera 52. Since there is a disparity between the first camera 51 and the second camera 52, a difference occurs in distances from the first camera 51 and the second camera 52 to an object to be photographed. However, since distance information used in the present invention is not a distance from each of the first camera 51 and the second camera 52 to the object, but a distance from a middle point between the centers of the first camera 51 and the second camera 52 to the object, such a difference does not become an issue.

As described above, the present invention is suitable for a mobile phone capable of providing video communication. This is because a distance to a photographed object is limited since a user usually uses the mobile phone while holding the mobile phone in his/her hand(s). The present invention is suitable for video communication using a Personal Computer (PC). Since a user performs video communication using a PC by sitting in front of a camera mounted in the PC and using a microphone, a change in a distance hardly occurs and is limited. The present invention can be applied to all types of devices that photograph images, such as a camcorder or a broadcasting camera that photographs moving images or a digital camera that photographs still images.

According to the present invention, an object to be shown in the entire photographed image can be accurately extracted regardless of a change in a pixel value or a similarity between colors by removing an image of an object at a predetermined distance using distance information extracted through two cameras. In addition, as a result of a small amount of computation, an image can be removed or synthesized with another image in real time.

While the invention has been shown and described with reference to a certain preferred embodiment thereof, it will be understood by those skilled in the art that various changes in form and details may be made therein without departing from the spirit and scope of the invention.

What is claimed is:

1. A method for processing an image, the method comprising the steps of:
photographing images using two cameras;
extracting distance information to a photographed object using a disparity between the images; and
processing the images of the photographed object at a predetermined distance using the extracted distance information.

2. The method of claim 1, further comprising the steps of:
mapping corresponding pixels in the images with respect to the same object;
calculating the disparity as a difference between positions of the corresponding pixels with respect to the same object in the images;
extracting the distance information to the photographed object using the calculated disparity;
removing the image of the photographed object at a predetermined distance using the extracted distance information; and
synthesizing another image into a portion corresponding to the removed image.

3. The method of claim 2, wherein the two cameras are spaced apart by a predetermined distance by making epipolar lines of the two cameras coincident.

4. The method of claim 3, wherein the images are same-sized images acquired by photographing the same object at the same time.

5. The method of claim 4, wherein mapping of the corresponding pixels is performed by comparing correlations in units of a sub-block with respect to the images.

6. The method of claim 5, wherein the distance information to the photographed image is calculated using distance information between centers of the cameras, focus length information of each of the cameras, and the disparity.

7. An apparatus for processing an image, the apparatus comprising:
two cameras for photographing images;
a pixel mapping unit for mapping corresponding pixels in the images photographed by the cameras with respect to the same object;
a distance information extracting unit for calculating a disparity between the images as a difference between positions of the corresponding pixels with respect to the same object in the images and extracting distance information to the photographed object using the disparity; and
an image synthesizing unit for processing the images of the photographed object at a predetermined distance using the distance information.

8. The apparatus of claim 7, wherein the two cameras are spaced apart by a predetermined distance by making epipolar lines of the two cameras coincident.

9. The apparatus of claim 8, wherein the images are same-sized images acquired by photographing the same object at the same time.

10. The apparatus of claim 9, wherein the pixel mapping unit maps the corresponding pixels by comparing correlations in units of a sub-block with respect to the images.

11. The apparatus of claim 10, wherein the distance information extracting unit calculates the distance information to the photographed object using distance information between centers of the cameras, focus length information of each of the cameras, and the disparity.

12. A mobile phone, comprising:
two cameras for photographing images;
a pixel mapping unit for mapping corresponding pixels in the images photographed by the cameras with respect to an object;
a distance information extracting unit for calculating a disparity between the images as a difference between positions of the corresponding pixels with respect to the same object in the images and extracting distance information to the photographed object using the disparity; and
an image synthesizing unit for processing the images of the photographed object at a predetermined distance using the distance information.

13. The mobile phone of claim 12, wherein the two cameras are spaced apart by a predetermined distance by making epipolar lines of the two cameras coincident.

14. The mobile phone of claim 13, wherein the images are same-sized images acquired by photographing the same object at the same time.

15. The mobile phone of claim 14, wherein the pixel mapping unit maps the corresponding pixels by comparing correlations in units of a sub-block with respect to the images.

16. The mobile phone of claim 15, wherein the distance information extracting unit calculates the distance information to the photographed object using distance information between centers of the cameras, focus length information of each of the cameras, and the disparity.
